(19) United States
(12) Patent Application Publication
(10) Pub. No.: US 2026/0089789 A1
(43) Pub. Date: Mar. 26, 2026

(54) TERMINAL APPARATUS, BASE STATION APPARATUS, AND METHOD

(71) Applicant: SHARP KABUSHIKI KAISHA, Sakai City, Osaka (JP)

(72) Inventors: TAICHI MIYAKE, Sakai City, Osaka (JP); Takuma KAWANO, Sakai City, Osaka (JP); HIDEKAZU TSUBOI, Sakai City, Osaka (JP); Kyosuke INOUE, Sakai City, Osaka (JP); Takaki NOMURA, Sakai City, Osaka (JP); SHOHEI YAMADA, Sakai City, Osaka (JP)

(21) Appl. No.: 19/143,507

(22) PCT Filed: Jun. 25, 2024
(86) PCT No.: PCT/JP2024/022936

§ 371 Date: Jun. 26, 2025

(30) Foreign Application Priority Data
Nov. 9, 2023 (JP) 2023-191253

(51) Int. Cl. H04W 76/19; H04W 76/40

(52) U.S. Cl. CPC H04W 76/19; H04W 76/40

(57) ABSTRACT

A terminal apparatus that communicates with a base station apparatus via a relay terminal apparatus, the terminal apparatus including an RRC entity, in which the RRC entity receives an indication to release a PC5 unicast link from a layer higher than an RRC layer, and initiates a procedure of performing RRC connection re-establishment with respect to the base station apparatus based on determining that the PC5 unicast link is a PC5 unicast link to the relay terminal apparatus.

### TECHNICAL FIELD

The present invention relates to a terminal apparatus, a base station apparatus, and a method.

This application claims priority to JP 2023-191253 filed on Nov. 9, 2023, the contents of which are incorporated herein by reference.

### BACKGROUND ART

The 3rd Generation Partnership Project (3GPP, trade name) being a standardization project for cellular mobile communication systems has carried out technical studies and standardization regarding cellular mobile communication systems including radio access, core networks, services, and the like.

For example, technical study and standardization of Evolved Universal Terrestrial Radio Access (E-UTRA) have begun in the 3GPP as a Radio Access Technology (RAT) for cellular mobile communication systems for the 3.9th generation and the 4th generation. Technical study and standardization of enhanced technology of E-UTRA are still being carried out in the 3GPP. Note that E-UTRA may also be referred to as Long Term Evolution (LTE: trade name), and its enhanced technology may also be referred to as LTE-Advanced (LTE-A) and LTE-Advanced Pro (LTE-A Pro).

Technical study and standardization of New Radio or NR Radio access (NR) have begun in the 3GPP as a Radio Access Technology (RAT) for cellular mobile communication systems for the 5th Generation (5G). Technical study and standardization of enhanced technology of NR are still carried out in the 3GPP.

### CITATION LIST

### Non Patent Literature

NPL 1: 3GPP TS 38.331 v17.3.0, “NR; Radio Resource Control (RRC); Protocol Specification” pp. 70-116, pp. 218-223, pp. 316-1107

NPL 2: 3GPP TS 38.321 v17.1.0, “NR; Medium Access Control (MAC) Protocol Specification” pp. 17-104

NPL 3: 3GPP TS 38.213 v17.1.0 “NR; Physical Layer Procedures for Control” pp. 14-20

NPL 4: 3GPP TS 38.351 v17.1.0, “NR, Sidelink Relay Adaptation Protocol (SRAP) Specification”

NPL 5: 3GPP TS 38.322 v17.1.0, “NR; Radio Link Control (RLC) Protocol Specification” pp. 13-30

NPL 6: 3GPP TS 38.323 v17.1.0, “NR, Packet Data Convergence Protocol (PDCP) Specification” pp. 13-20, pp. 33-39

NPL 7: 3GPP TS 38.300 v17.2.0, “NR; NR and NG-RAN Overall Description” pp. 43-44, pp. 166-175

### SUMMARY OF INVENTION

### Technical Problem

In the 3GPP, as an extended technique of NR, a technique called sidelink (SL) in which a terminal apparatus and another terminal apparatus directly communicate with each other without a core network has been studied, and a technique called UE-to-Network relay (U2N relay) in which a relay terminal apparatus provides communication through sidelink to enable a terminal apparatus to communicate with a base station apparatus via a relay terminal apparatus and a study on reinforced service continuity for U2N Relay have been started.

### Solution to Problem

In order to accomplish the object described above, an aspect of the present invention is contrived to provide the following means. That is, according to a first aspect, the present invention is a terminal apparatus that communicates with a base station apparatus via a relay terminal apparatus, the terminal apparatus including an RRC entity, in which the RRC entity receives an indication to release a PC5 unicast link from a layer higher than an RRC layer, and initiates a procedure of performing RRC connection re-establishment with respect to the base station apparatus based on determining that the PC5 unicast link is a PC5 unicast link to the relay terminal apparatus.

In addition, according to another aspect, the present invention is a base station apparatus that communicates with a terminal apparatus via a relay terminal apparatus, the terminal apparatus including an RRC entity, and the RRC entity receives an indication to release a PC5 unicast link from a layer higher than an RRC layer, and initiates a procedure of performing RRC connection re-establishment with respect to the terminal apparatus based on determining that the PC5 unicast link is a PC5 unicast link to the relay terminal apparatus.

In addition, according to another aspect, the present invention is a method of a terminal apparatus that communicates with a base station apparatus via a relay terminal apparatus, the terminal apparatus including an RRC entity, in which the RRC entity receives an indication to release a PC5 unicast link from a layer higher than an RRC layer, and initiates a procedure of performing RRC connection re-establishment with respect to the base station apparatus based on determining that the PC5 unicast link is a PC5 unicast link to the relay terminal apparatus.

### Advantageous Effects of Invention

An aspect of the present invention is made in view of the circumstances described above, and has an object to provide a terminal apparatus, a base station apparatus, a method, and an integrated circuit that enable efficient communication control.

According to an aspect of the present invention, a terminal apparatus, a method, and an integrated circuit that implement efficient communication control processing can be provided.

### BRIEF DESCRIPTION OF DRAWINGS

FIG. 1 is a schematic diagram of a communication system according to the present embodiment.

FIG. 2 is a diagram of an example of a protocol configuration of NR sidelink communication according to the present embodiment.

FIG. 3 is a diagram of an example of a protocol configuration of NR sidelink communication according to the present embodiment.

FIG. 4 is a diagram of an example of a protocol configuration in a discovery procedure according to the present embodiment.

FIG. 5 is a block diagram illustrating a configuration of a terminal apparatus according to the present embodiment.

FIG. 6 is a block diagram illustrating a configuration of a base station apparatus according to the present embodiment.

FIG. 7 is a diagram of an example of a protocol configuration for NR according to the present embodiment.

FIG. 8 is a diagram of an example of a protocol configuration of a control plane in L2 U2N relay according to the present embodiment.

FIG. 9 is a diagram of an example of a protocol configuration of a user plane in L2 U2N relay according to the present embodiment.

FIG. 10 is an example of processing according to the present embodiment.

### DESCRIPTION OF EMBODIMENTS

The present embodiment will be described below in detail with reference to the drawings.

Note that, although terms of each node and entity, processing at each node and entity, and the like in a case that the radio access technology is NR will be described in the present embodiment, the present embodiment may be applied to other radio access technologies. In the present embodiment, the terms of each node and entity may be other terms.

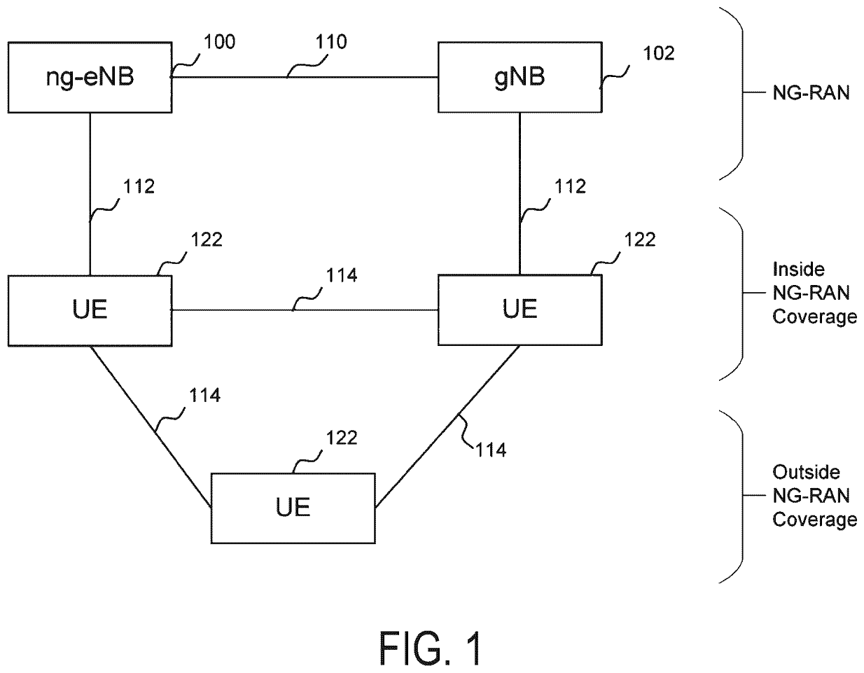

FIG. 1 is a schematic diagram of a communication system according to the present embodiment. Note that functions such as each node, radio access technology, core network, and interface to be described with reference to FIG. 1 are a part of functions closely related to the present embodiment, and other functions may be provided.

E-UTRA may be a radio access technology. The E-UTRA may be an air interface between a UE 122 and an ng-eNB 100. An air interface 112 between the UE 122 and the ng-eNB 100 may be referred to as a Uu interface. The ng E-UTRAN Node B (ng-eNB) 100 may be a base station apparatus of the E-UTRAN. The ng-eNB 100 may have an E-UTRA protocol to be described below. The E-UTRA protocol may include an E-UTRA User Plane (UP) protocol to be described below and an E-UTRA Control Plane (CP) protocol to be described below. The ng-eNB 100 may terminate the E-UTRA user plane protocol and the E-UTRA control plane protocol for the UE 122. A radio access network including the eNB may be referred to as an E-UTRAN.

NR may be a radio access technology. The NR may be an air interface between the UE 122 and a gNB 102. The air interface 112 between the UE 122 and the gNB 102 may be referred to as a Uu interface. The g Node B (gNB) 102 may be a base station apparatus of NR. The gNB 102 may have an NR protocol to be described below. The NR protocol may include an NR User Plane (UP) protocol to be described below and an NR Control Plane (CP) protocol to be described below. The gNB 102 may terminate the NR user plane protocol and the NR control plane protocol for the UE 122.

Note that the interface 110 between the ng-eNB 100 and the gNB 102 may be referred to as an Xn interface. The ng-eNB and the gNB may be connected to the 5GC via an interface called an NG interface (not illustrated). The 5GC may be a core network. One or multiple base station apparatuses may connect to the 5GC via the NG interface.

A state in which connection to the base station apparatus only via the Uu interface is enabled may be referred to as Inside NG-RAN Coverage or In-Coverage (IC). In addition, a state in which connection to the base station apparatus only via the Uu interface is disabled may be referred to as Outside NG-RAN Coverage or Out-of-Coverage (OoC). The air interface 114 between the UE 122 and the UE 122 may be referred to as a PC5 interface. Communication between the UEs 122 via the PC5 interface may be referred to as sidelink (SL) communication. A terminal apparatus that can perform sidelink communication may be referred to as a terminal apparatus capable of sidelink communication.

Note that, in the following description, the ng-eNB 100 and/or the gNB 102 is also simply referred to as a base station apparatus, and the UE 122 is also simply referred to as a terminal apparatus or a UE. The PC5 interface is also simply referred to as PC5, and the Uu interface is also simply referred to as Uu.

Sidelink is a technique for performing direct communication between terminal apparatuses via PC5, and sidelink transmission and/or reception on the PCS is performed inside the NG-RAN coverage and outside the NG-RAN coverage.

NR SL communication has three transmission modes, and SL communication is performed in any one of the transmission modes with a pair of a source layer-2 identifier (Source Layer-2 (L2) ID) and a destination layer-2 identifier (Destination Layer-2 (L2) ID). The source layer-2 identifier and the destination layer-2 identifier may be referred to as a source L2ID and a destination L2ID, respectively. The three transmission modes are “unicast transmission”, “groupcast transmission”, and “broadcast transmission”. Note that the transmission modes may be referred to as cast types or the like. Note that unicast transmission in direct communication may be supported on PC5, and a PC5 unicast link between two UEs may be established for direct communication. In addition, the PC5 unicast link may be added, modified, or released according to application-layer requirements or communication requirements.

Unicast transmission is characterized by (1) support for one PC5-RRC connection between paired UEs, (2) transmission and/or reception of control information and user traffic between UEs in sidelink, (3) support for sidelink HARQ feedback, (4) transmission power control in sidelink, (5) support for RLC AM, and (6) detection of failure in radio link for PC5-RRC connections.

Groupcast transmission is characterized by (1) transmission and/or reception of user traffic between UEs belonging to a sidelink group and (2) support of sidelink HARQ feedback.

Broadcast transmission is characterized by (1) transmission and/or reception of user traffic between UEs on the sidelink.

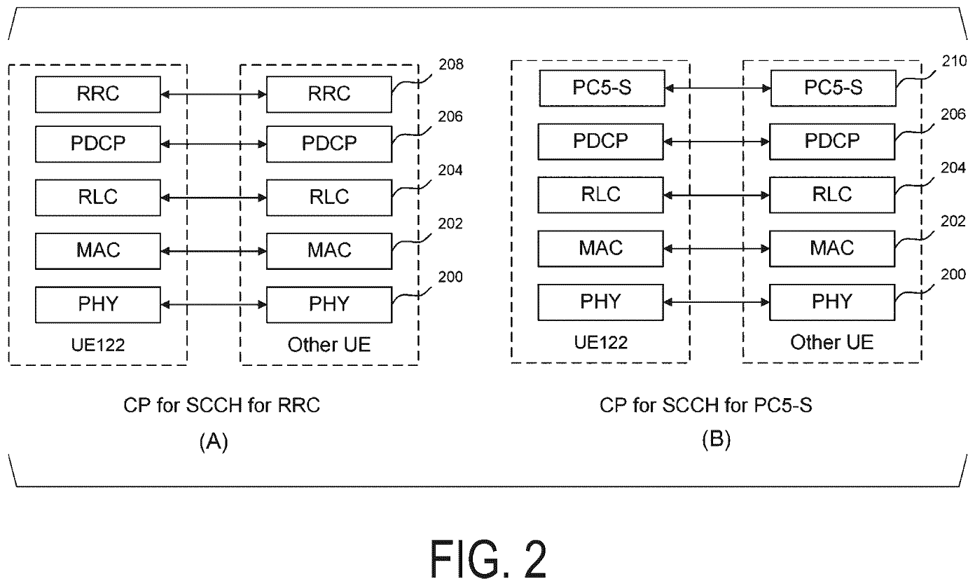

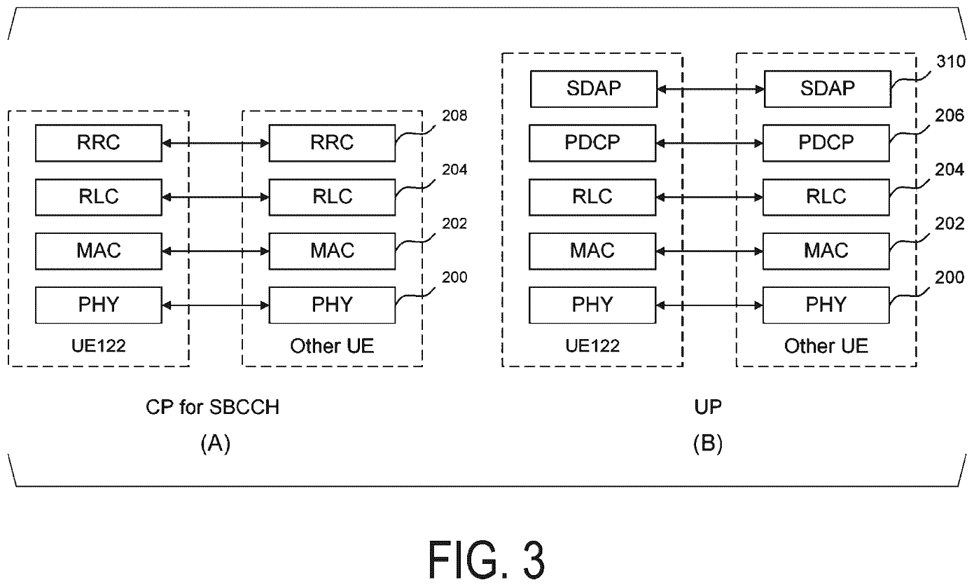

FIGS. 2 and 3 are diagrams of an example of a protocol configuration in NR sidelink communication according to the present embodiment. Note that functions of each protocol to be described with reference to FIG. 2 and/or FIG. 3 are a part of functions closely related to the present embodiment, and other functions may be provided. Note that, in the present embodiment, the sidelink (SL) may be a link between a terminal apparatus and a terminal apparatus.

FIG. 2(A) is a diagram of a protocol stack of the Control Plane (CP) for an SCCH with RRC, which is configured on the PC5 interface. As illustrated in FIG. 2(A), the control plane protocol stack for the SCCH with RRC may include a Physical layer (PHY) 200 which is a radio physical layer, a Medium Access Control (MAC) 202 which is a medium access control layer, a Radio Link Control (RLC) 204 which is a radio link control layer, and a Packet Data Convergence Protocol (PDCP) 206 which is a packet data convergence protocol layer, and a Radio Resource Control (RRC) 208 which is a radio resource control layer. FIG. 2(B) is a diagram of the protocol stack of the control plane for the SCCH with PC5-S, which is configured on the PC5 interface. As illustrated in FIG. 2(B), the control plane protocol stack for the SCCH with PC5-S may include the Physical layer (PHY) 200 which is a radio physical layer, the Medium Access Control (MAC) 202 which is a medium access control layer, the Radio Link Control (RLC) 204 which is a radio link control layer, and the Packet Data Convergence Protocol (PDCP) 206 which is a packet data convergence protocol layer, and a PC5 Signalling (PCS-S) 210 which is a PC5 signalling layer.

FIG. 3(A) is a diagram of the protocol stack of the control plane for an SBCCH, which is configured on the PC5 interface. As illustrated in FIG. 3(A), the control plane protocol stack for the SBCCH may include the Physical layer (PHY) 200 which is a radio physical layer, the Medium Access Control (MAC) 202 which is a medium access control layer, the Radio Link Control (RLC) 204 which is a radio link control layer, and the Radio Resource Control 208 (RRC) which is a radio resource control layer. FIG. 3(B) is a diagram of the protocol stack of the User Plane (UP) for an STCH, which is configured on the PC5 interface. As illustrated in FIG. 3(B), the control plane protocol stack for the STCH may include the Physical layer (PHY) 200 which is a radio physical layer, the Medium Access Control (MAC) 202 which is a medium access control layer, the Radio Link Control (RLC) 204 which is a radio link control layer, the Packet Data Convergence Protocol (PDCP) 206 which is a packet data convergence protocol layer, and a Service Data Adaptation Protocol (SDAP) 310 which is a service data adaptation protocol layer.

Note that an Access Stratum (AS) layer may be a layer including some or all of the PHY 200, the MAC 202, the RLC 204, the PDCP 206, the SRAP 800, the SDAP 310, and the RRC 208. The PC5-S 210 and a Discovery 400 described below may be layers higher than the AS layer.

Note that the present embodiment may use terms such as a PHY (PHY layer), a MAC (MAC layer), an RLC (RLC layer), a PDCP (PDCP layer), an SDAP (SDAP layer), an RRC (RRC layer), and a PC5-S (PC5-S layer). In this case, the PHY (PHY layer), the MAC (MAC layer), the RLC (RLC layer), the PDCP (PDCP layer), the SDAP (SDAP layer), the RRC (RRC layer), and the PC5-S (PC5-S layer) may respectively be the PHY (PHY layer), the MAC (MAC layer), the RLC (RLC layer), the PDCP (PDCP layer), the SDAP (SDAP layer), the RRC (RRC layer), and the PC5-S (PC5-S layer) of the NR sidelink protocol. Note that, in a case that sidelink communication is performed using the E-UTRA technology, the SDAP layer may not be provided. Note that, in order to clarify a protocol for sidelink, for example, RLC may be expressed as sidelink RLC, SLRLC, PC5 RLC, or the like, and other protocols may also be expressed as a protocol for sidelink by putting a prefix of “sidelink”, “SL” or “PC5”.

In addition, in the present embodiment, in a case that the protocol of E-UTRA and the protocol of NR are distinguished from each other, the PHY, the MAC, the RLC, the PDCP, and the RRC may be hereinafter respectively referred to as a PHY for E-UTRA or a PHY for LTE, a MAC for E-UTRA or a MAC for LTE, an RLC for E-UTRA or an RLC for LTE, a PDCP for E-UTRA or a PDCP for LTE, and an RRC for E-UTRA or an RRC for LTE. The PHY, the MAC, the RLC, the PDCP, and the RRC may respectively be referred to as an E-UTRA PHY or an LTE PHY, an E-UTRA MAC or an LTE MAC, an E-UTRA RLC or an LTE RLC, an E-UTRA PDCP or an LTE PDCP, an E-UTRA RRC or an LTE RRC, and the like. In addition, in a case that the protocol of E-UTRA, the protocol for sidelink, and the protocol of NR are distinguished from each other, the PHY, the MAC, the RLC, the PDCP, and the RRC may respectively be referred to as a PHY for NR, a MAC for NR, an RLC for NR, an RLC for NR, and an RRC for NR. The PHY, the MAC, the RLC, the PDCP, and the RRC may respectively be referred to as an NR PHY, an NR MAC, an NR RLC, an NR PDCP, an NR RRC, and the like.

Entities in the AS layer of E-UTRA, NR, and/or sidelink will be described. An entity having a part or all of functions of the physical layer may be referred to as a PHY entity. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The PHY entity, the MAC entity, the RLC entity, the PDCP entity, the SDAP entity, and the RRC entity may respectively be rephrased as a PHY, a MAC, an RLC, a PDCP, an SDAP, and an RRC. In addition, each entity in the AS layer may be an entity common to E-UTRA, NR, and/or sidelink, or may be an independent entity.

Note that data provided from the MAC, the RLC, the PDCP, and the SDAP to a lower layer, and/or data provided to the MAC, the RLC, the PDCP, and the SDAP from a lower layer may be referred to as a MAC Protocol Data Unit (PDU), an RLC PDU, a PDCP PDU, and an SDAP PDU, respectively. Data provided to the MAC, the RLC, the PDCP, and the SDAP from a higher layer, and/or data provided from the MAC, the RLC, the PDCP, and the SDAP to a higher layer may be referred to as a MAC Service Data Unit (SDU), an RLC SDU, a PDCP SDU, and an SDAP SDU, respectively. A segmented RLC SDU may be referred to as an RLC SDU segment.

Here, the base station apparatus and the terminal apparatus exchange (transmit and/or receive) signals with each other in higher layers on the Uu interface. The higher layer may be referred to as a higher layer, and may be paraphrased with each other. For example, the base station apparatus and the terminal apparatus may transmit and/or receive an RRC message (also referred to as RRC signalling) in the Radio Resource Control (RRC) layer. In the Medium Access Control (MAC) layer, the base station apparatus and the terminal apparatus may transmit and/or receive a MAC Control Element (MAC CE). Additionally, the RRC layer of the terminal apparatus acquires system information broadcast from the base station apparatus. Here, the RRC message, the system information, and/or the MAC control element are also referred to as higher layer signaling or higher layer parameters. Each of the parameters included in the higher layer signaling received by the terminal apparatus may be referred to as a higher layer parameter For example, in the processing of the PHY layer, the higher layer means a higher layer as viewed from the PHY layer, and thus may mean one or multiple of the MAC layer, the RRC layer, an RLC layer, a PDCP layer, a Non Access Stratum (NAS) layer, and the like. For example, in the processing of the MAC layer, the higher layer may mean one or multiple of the RRC layer, the RLC layer, the PDCP layer, the NAS layer, and the like.

On the PC5 interface, the terminal apparatuses exchange (transmit and/or receive) signals with each other in higher layers. The terminal apparatuses may transmit and/or receive an RRC message (also referred to as RRC signalling) in the Radio Resource Control (RRC) layer. In the Medium Access Control (MAC) layer, the terminal apparatuses may transmit and/or receive a MAC Control Element (MAC CE). In this regard, the RRC message and/or the MAC control element are also referred to as higher layer signaling or a higher layer parameter. Each of the parameters included in the higher layer signaling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, the RLC layer, the PDCP layer, the PC5-S layer, the Discovery layer, and the like. For example, in the processing of the MAC layer, the higher layer may mean one or multiple of the RRC layer, the RLC layer, the PDCP layer, the PC5-S layer, the Discovery layer, and the like.

Hereinafter, “A is given (provided) in the higher layer” or “A is given (provided) by the higher layer” may mean that the higher layer (mainly the RRC layer, the MAC layer, or the like) of the terminal apparatus receives A from the base station apparatus or another terminal apparatus, and that the received A is given (provided) from the higher layer of the terminal apparatus to the physical layer of the terminal apparatus. For example, “a higher layer parameter being provided” in the terminal apparatus may mean that higher layer signaling is received from the base station apparatus or another terminal apparatus, and a higher layer parameter included in the received higher layer signaling is provided from the higher layer of the terminal apparatus to the physical layer of the terminal apparatus. A higher layer parameter being configured for the terminal apparatus may mean that the higher layer parameter is given (provided) to the terminal apparatus. For example, a higher layer parameter being configured for the terminal apparatus may mean that the terminal apparatus receives higher layer signaling from the base station apparatus or another terminal apparatus and configures the received higher layer parameter in the higher layer. However, a higher layer parameter being configured for the terminal apparatus may include a default parameter given in advance being configured in the higher layer of the terminal apparatus. In description of transmission of an RRC message from the terminal apparatus to the base station apparatus or another terminal apparatus, the expression that a message is submitted from the RRC entity of the terminal apparatus to a lower layer may be used. In the terminal apparatus, “submitting a message to a lower layer” from the RRC entity may mean submitting a message to the PDCP layer. In the terminal apparatus, “submitting a message to a lower layer” from the RRC layer may mean to submit the message of the RRC to a PDCP entity corresponding to each SRB (SRB0, SRB1, SRB2, SRB3, or the like) because the message of RRC is transmitted using the SRB. In a case that the RRC entity of the terminal apparatus receives an indication from the lower layer, the lower layer may mean one or multiple of the PHY layer, the MAC layer, the RLC layer, the PDCP layer, and the like.

An example of the functions of the PHY will be described. The PHY of the terminal apparatus may have a function of transmitting and/or receiving transmitted data to and/or from the PHY of another terminal apparatus via a sidelink (SL) Physical Channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Now, the physical channels will be described. The physical channels used for radio communication between the terminal apparatus and another terminal apparatus may include the following physical channels.
Physical Sidelink Broadcast CHannel (PSBCH)
Physical Sidelink Control CHannel (PSCCH)
Physical Sidelink Shared CHannel (PSSCH)
Physical Sidelink Feedback CHannel (PSFCH)

The PSBCH may be used to broadcast system information required by the terminal apparatus.

The PSCCH may be used to indicate resources or other transmission parameters for the PSSCH.

The PSSCH may be used to transmit data and control information related to HARQ/CSI feedback to another terminal apparatus.

The PSFCH may be used to carry HARQ feedback to another terminal apparatus.

An example of the functions of the MAC will be described. The MAC may be referred to as a MAC sublayer. The MAC may have a function of mapping various Logical Channels to their corresponding transport channels. The logical channel may be identified with a Logical Channel Identity (or Logical Channel ID). The MAC may be connected to an upper RLC with a logical channel. The logical channel may be classified into a control channel for transmitting control information and a traffic channel for transmitting user information depending on the type of information to be transmitted. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to a higher layer via the logical channels to which the respective MAC SDUs belong. The MAC may have a function of performing error correction through a Hybrid Automatic Repeat reQuest (HARQ). The MAC may have a function of reporting scheduling information. The MAC may have a function of performing priority processing among the terminal apparatuses by using dynamic scheduling. The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of signalling information of transmittable power, a Buffer Status Report (BSR) function of signalling data volume information of a transmission buffer, and the like. The NR MAC may have a Bandwidth Adaptation (BA) function. A MAC PDU format used in the E-UTRA MAC and a MAC PDU format used in the NR MAC may be different from each other. The MAC PDU may include a MAC control element (MAC CE) being an element for performing control in the MAC.

The MAC sublayer may additionally provide, on the PC5 interface, services and functions, such as radio resource selection for selecting a radio resource for sidelink transmission, filtering of packets received through sidelink communication, priority processing between the uplink and the sidelink, reporting of Sidelink Channel State Information (Sidelink CSI).

Mapping, which is used in E-UTRA and/or NR, between a sidelink (SL) logical channel and a sidelink logical channel and a transport channel will be described.

A Sidelink Broadcast Control Channel (SBCCH) may be a sidelink logical channel for broadcasting sidelink system information from one terminal apparatus to one or multiple terminal apparatuses. The SBCCH may be mapped to an SL-BCH that is a sidelink transport channel.

A Sidelink Control Channel (SCCH) may be a sidelink logical channel for transmitting control information such as a PC5-RRC message and a PC5-S message from one terminal apparatus to one or multiple terminal apparatuses. The SCCH may be mapped to an SL-SCH that is a sidelink transport channel.

A Sidelink Traffic Control Channel (STCH) may be a sidelink logical channel for transmitting user information from one terminal apparatus to one or multiple terminal apparatuses. The STCH may be mapped to the SL-SCH that is a sidelink transport channel.

An example of the functions of the RRC will be described. RRC may support services and functions on the PC5 interface such as forwarding of PC5-RRC messages between peer UEs, maintenance and release of the PCS-RRC connection between two UEs, and detection of a failure in sidelink radio link for PC5-RRC connection. The PC5-RRC connection is considered to be a logical connection between two UEs corresponding to a pair of a source L2ID and a destination L2ID and to be established after a corresponding PC5 unicast link is established. There is a one-to-one correspondence between the PC5-RRC connection and the PC5 unicast link. The UE may have multiple PCS-RRC connections to one or multiple UEs for different pairs of source L2IDs and destination L2IDs. A separate PC5-RRC procedure and separate messages may be used for the UE to transfer UE capabilities and sidelink configurations to peer UE. Both peer UEs may exchange the UE capabilities and sidelink configurations thereof with each other using a separate bi-directional procedure. The UEs release the PC5-RRC connection in a case that the UEs are not interested in sidelink transmission, that a failure in sidelink radio link for the PC5-RRC connection is detected, and that the Layer-2 link release procedure is completed.

The UE that performs sidelink transmission may transmit the PSCCH and the PSSCH in association with each other. Note that the sidelink transmission may be transmission of a signal and/or data (message) via a physical channel for sidelink (PSBCH, PSSCH, PSCCH, etc.), and the sidelink reception may be reception of a signal and/or data (message) via a physical channel for sidelink. In addition, communication using sidelink transmission and sidelink reception may be referred to as sidelink communication. The UE may recognize the data (message) based on the signal. Each operation of PSSCH transmission may be associated with a certain operation of PSCCH transmission. The PSCCH transmission may carry a first stage of the SCI (first SCI) associated with the PSSCH transmission, and a second stage of the SCI (second SCI) may be carried within resources of the PSSCH. Note that the PSCCH transmission may include the first SCI, and the PSSCH transmission may include the second SCI. In addition, the PSCCH transmission and the PSSCH transmission may be referred to as sidelink transmission, and the SCI may be sidelink control information (SidelinkControl Information). The first SCI may include information in a format called SCI format 1-A (SCIformat 1-A), and may be used for scheduling of the second SCI on the PSSCH and the PSSCH. The SCI format 1-A may include information such as a priority of data, a frequency resource and a time resource in which the PSSCH is transmitted, a resource reservation period, a DMRS mapping pattern, a format of the second SCI, an indication value of a beta offset, the number of DMRS ports, and information indicating a modulation and coding scheme, and may include other information. In addition, the SCI carried on the PSSCH may be a second SCI, and the second SCI may transport sidelink scheduling information and/or inter-UE coordination related information. The second SCI may include information in a format called an SCI format 2-A, an SCI format 2-B, an SCI format 2-C, or the like. The SCI format 2-A, the SCI format 2-B, and the SCI format 2-C may include information such as HARQ process-related information, information indicating whether data is new, a redundancy version, a source ID for identifying a source UE, a destination ID for identifying a destination UE, and information indicating whether HARQ feedback is possible. In addition, the SCI format 2-A may include information indicating a cast type and information indicating whether to request channel state information (CSI). The SCI format 2-B may additionally include an identifier indicating a zone and request information related to a communication range. In addition, the SCI format 2-C may include information indicating whether to additionally request channel state information and information indicating whether to provide or request inter-UE coordination information. In a case that the SCI format 2-C includes information for providing inter-UE coordination information, the SCI format 2-C may additionally include information indicating a combination of resources, information indicating a first resource position, position information of a reference slot, information indicating the type of a resource set, a lowest subchannel index, and the like. In a case that the SCI format 2-C includes information requesting inter-UE coordination information, the SCI format 2-C may additionally include information such as a priority, the number of subchannels, a resource reservation interval, a position of a resource selection window, information indicating the type of a resource set, and the like. Note that each SCI format may include information other than the information described above.

Next, a procedure of the UE to receive the PSSCH will be described below. Upon detecting the SCI format 1-A on the PSCCH, the UE may decode the PSSCH according to the detected SCI format 2-A or SCI format 2-B and the associated PSSCH resource configuration made by the higher layer. Note that the UE does not need to decode more than one PSCCH in each PSCCH resource candidate. In addition, in a case that the UE does not support the modulation and coding scheme indicated by the SCI format 1-A, the UE does not need to decode the corresponding SCI format 2-A and SCI format 2-B, and the PSSCH associated with the SCI format 1-A.

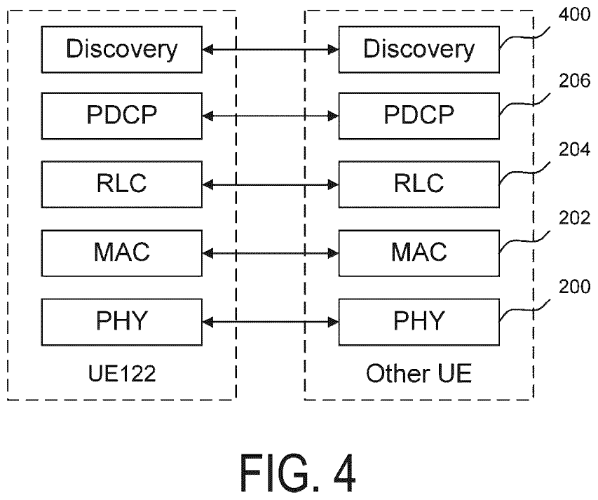

A terminal apparatus capable of sidelink communication may perform discovery. Discovery may include Model A and Model B. FIG. 4 illustrates a protocol stack used in a discovery procedure. Mode A may use a single discovery protocol message and Model B may use two discovery protocol messages. The single discovery protocol message in Model A may be an announcement message, and the discovery protocol message in Model B may include a solicitation message and a response message. Note that the announcing message, the solicitation message, and the response message may be collectively referred to as a discovery message, and a message having another name used in the discovery procedure may be referred to as a discovery message. The outline of a procedure for Model A and Model B in ProSe Direct Discovery will be described below.

In Model A, a UE that transmits an announcing message may be referred to as an Announcing UE, and a UE that monitors the announcing message may be referred to as a Monitoring UE. The announcing message may include information such as the type of a discovery message, a ProSe Application Code or a ProSe Restricted Code, or a security protection element, and may additionally include metadata information. The announcing message is transmitted using a Destination Layer-2 ID (destination L2ID) and a Source Layer-2 ID (source L2ID), and the monitoring UE determines the destination L2ID to receive the announcing message. Note that the destination L2ID may be a Layer-2 identifier of the destination UE, and the source L2ID may be a Layer-2 identifier of the source UE. The destination UE may be simply referred to as a destination.

In Model B, a UE transmitting a solicitation message may be referred to as a discoverer UE, and a UE receiving the solicitation message and/or a UE transmitting a response message to the discoverer UE may be referred to as a discoveree UE. The solicitation message may include information such as a type of the discovery message, a ProSe Query Code, and a security protection element. The solicitation message is transmitted using the destination L2ID and the source L2ID, and the discoveree UE determines the destination L2ID to receive the solicitation message. The discoveree UE responding to the solicitation message transmits the response message. The response message may include information such as the discovery message type, a ProSe Response Code, and the security protection element, and may additionally include metadata information. The response message is transmitted using the source L2ID, and the destination L2ID is set to the source L2ID of the received solicitation message.

Discovery may include types other than ProSe Direct Discovery in which another UE is discovered in order to perform direct communication with the other UE, and may include Group member Discovery in which one or multiple UEs are discovered in order to perform communication within a group using sidelink, 5G ProSe UE-to-Network Relay Discovery in which candidate relay terminal apparatuses are discovered in order to connect to the network via a relay terminal apparatus, and the like. Although the above-described discovery is an example of discovery provided by an application called ProSe, in addition to the above-described type, different types of discovery may be present according to an application or service for sidelink communication. Information included in the discovery protocol message may vary according to the type of discovery, and an additional message may be transmitted to transmit additional information.

FIG. 4 is a diagram of an example of a protocol configuration including the discovery protocol according to the present embodiment. As illustrated in FIG. 4, a protocol stack of a discovery plane including the discovery protocol may include the Physical layer (PHY) 200 which is a radio physical layer, the Medium Access Control (MAC) 202 which is a medium access control layer, the Radio Link Control (RLC) 204 which is a radio link control layer, a Packet Data Convergence Protocol (PDCP) 206 which is a packet data convergence protocol layer, and Discovery 400 which is a discovery protocol layer. The Discovery 400 may be a protocol used to handle procedures related to discovery. An interface between UEs performing discovery may be referred to as PC5-D.

Multiple resource pools for transmitting a message used in the procedure related to discovery (discovery message) may be configured, and one or multiple resource pools may be configured as dedicated to discovery. In a case that a dedicated resource pool for discovery is configured, the UE may use the dedicated resource pool for discovery as a resource pool for transmitting the discovery message, and in a case that no dedicated resource pool for discovery is configured, the UE may use the resource pool for sidelink communication as the resource pool for transmitting the discovery message. Note that multiple resource pools for sidelink communication may be configured together with multiple dedicated resource pools for discovery. Each resource pool may be configured by dedicated signaling for UE or may be preconfigured.

In each unicast PCS-RRC connection, Signaling Radio Bearers (SRBs) for sidelink may be configured. The SRB for sidelink used to transmit the PC5-S message before PC5-S security is established may be referred to as an SL-SRB0. In addition, the SRB for sidelink used to transmit the PC5-S message to establish PC5-S security may be referred to as an SL-SRB1. In addition, after the PC5-S security is established, the SRB for the sidelink used for transmitting a protected PC5-S message may be referred to as an SL-SRB2. In addition, after the PCS-S security is established, the SRB for the sidelink used to transmit the protected PC5-RRC signalling may be referred to as an SL-SRB3. In addition, the SRB for sidelink used for transmitting and/or receiving the discovery message in the NR may be referred to as an SL-SRB4. Note that the PC5-RRC signalling may be inter-UE RRC signalling transmitted and/or received on the PC5. Note that the PC5-RRC signalling may be referred to as a PC5-RRC message or the like.

A multi-path relay (or multi-path relaying) will be described. Multi-path relay may be a technology in which a terminal apparatus communicates with a base station apparatus using two paths, a direct path and an indirect path. The direct path may be a path through which a terminal apparatus directly communicates with a base station apparatus via the Uu interface. In addition, the indirect path may be a path through which a terminal apparatus communicates with a base station apparatus via a relay terminal apparatus. The interface between the terminal apparatus and the relay terminal apparatus may be a PC5 interface or a different interface. In addition, the relay terminal apparatus may be a terminal apparatus playing the role of a U2N relay UE.

In the multi-path relay, a bearer mapped to a direct path may be referred to as a direct bearer, a bearer mapped to an indirect path may be referred to as an indirect bearer, and a bearer mapped to both a direct path and an indirect path may be referred to as a multi-path (MP) split bearer or simply a split bearer.

Here, UE-to-Network (U2N) relay will be described. U2N relay may be a function of providing connectivity to a network for a remote terminal apparatus (remote UE). A remote terminal apparatus that connects to a network by using U2N relay may be referred to as a U2N remote UE. In addition, a terminal apparatus that provides connectivity to a network for the U2N remote UE may be referred to as a U2N relay terminal apparatus (relay UE) or simply a relay terminal apparatus (relay UE). The U2N relay UE may use the Uu interface for communication with the base station apparatus, or may use the PCS interface for communication with the U2N remote UE. In addition, the U2N relay may include Layer-2 (L2) U2N relay, Layer-3 (L3) U2N relay, and the like. A remote terminal apparatus in the L2 U2N relay may be particularly referred to as an L2 U2N remote UE, and a relay terminal apparatus in the L2 U2N relay may be particularly referred to as an L2 U2N relay UE, and may be referred to as a serving relay terminal apparatus or a serving relay UE. In addition, in L2 U2N relay, there may be a sidelink relay adaptation protocol (SRAP) layer.

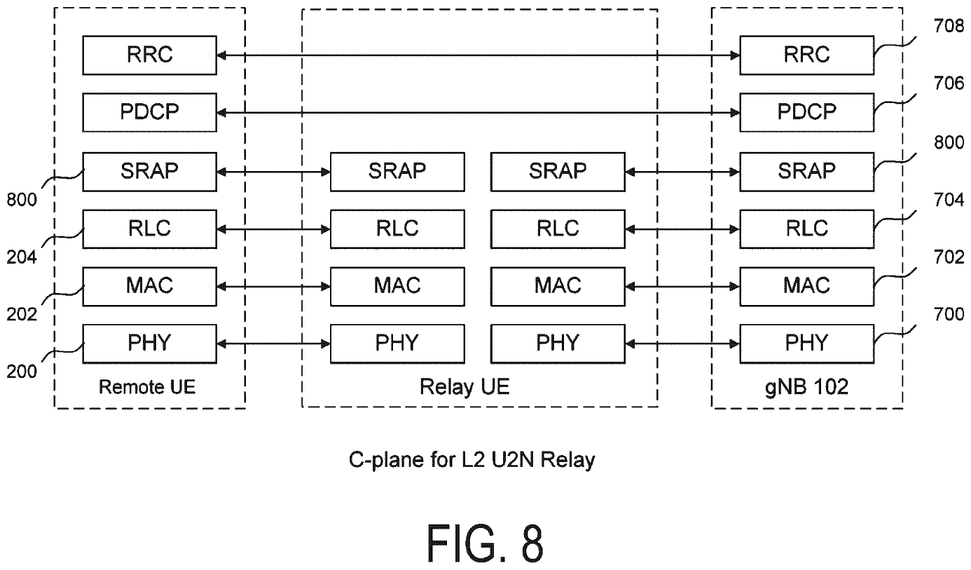

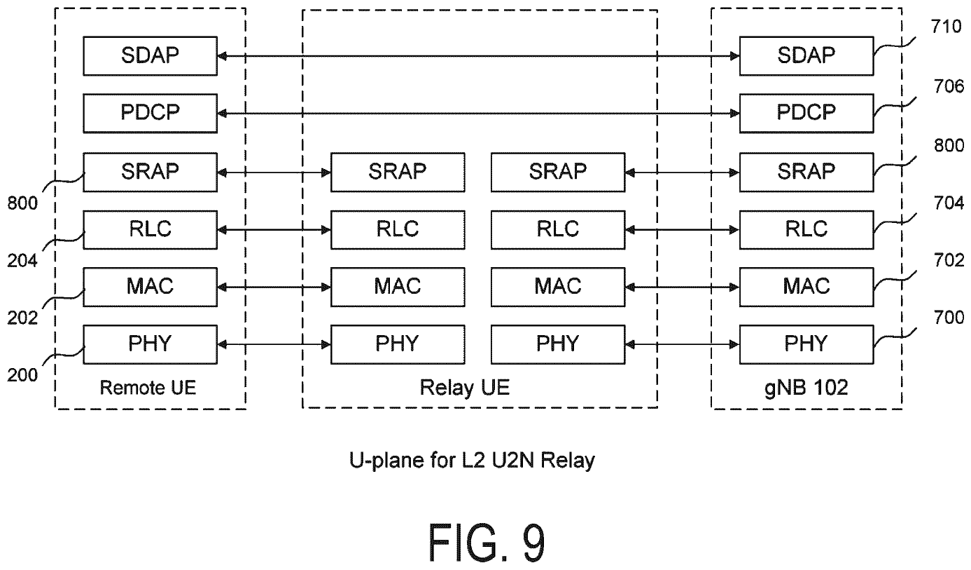

FIG. 8 is a diagram of an example of a protocol configuration of a control plane (C-plane) of L2 U2N relay including the SRAP layer (SRAP 800) according to the present embodiment. In addition, FIG. 9 is a diagram of an example of a protocol configuration of a user plane (U-plane) of L2 U2N relay including the SRAP layer according to the present embodiment. As illustrated in FIGS. 8 and 9, the SRAP layers of the remote UE and the relay UE may be associated, and the SRAP layers of the relay UE and the gNB 102 may also be associated. Note that the gNB 102 illustrated in FIGS. 8 and 9 may be the ng-eNB 100. In addition, the remote UE or the relay UE may be the UE 122. In addition, the relay UE may have the same configuration as the UE 122.

Here, the SRAP layer will be described. The SRAP layer may be referred to as an SRAP sublayer, or simply SRAP. The SRAP sublayer may be present above the RLC sublayer for the control and user planes of both the PCS and Uu interfaces. The SRAP sublayer on the PC5 may be used for bearer mapping. In the L2 U2N relay UE, the SRAP sublayer includes one SRAP entity on the Uu interface, and may include an SRAP entity separate collocated on the PC5interface. In the L2 U2N remote UE, the SRAP sublayer may include only one SRAP entity on the PC5 interface. The SRAP entities associated between the remote UE and the relay UE on the PC5 interface may be particularly referred to as a PC5-SRAP, and the SRAP entities associated between the relay UE and the gNB on the Uu may be particularly referred to as a Uu-SRAP. In addition, when interface names are clarified, other entities may be expressed in the format (interface name)-(entity name), similarly to those of SRAP. Each SRAP entity may have a transmitter and a receiver. On the PCS interface, the transmitter of the SRAP entity of the L2 U2N remote UE may be associated with the receiver of the SRAP entity of the L2 U2N relay UE, and the receiver of the SRAP entity of the L2 U2N remote UE may be associated with the transmitter of the SRAP entity of the L2 U2N relay UE. In addition, on the Uu interface, the transmitter of the SRAP entity of the L2 U2N relay UE may be associated with the receiver of the SRAP entity of the gNB 102, and the receiver of the SRAP entity of the L2 U2N relay UE may be associated with the transmitter of the SRAP entity of the gNB 102.

In addition, the SRAP entities may have a function of transferring data, a function of determining a UE ID field and a bearer ID field of an SRAP header to be added to a data packet, a function of determining an exit link, and a function of determining an exit RLC channel.

In addition, in FIGS. 8 and 9, a PC5 relay RLC channel may be configured between the remote UE and the relay UE, and a Uu relay RLC channel may be configured between the relay UE and the gNB 102.

Next, a protocol configuration used between the base station apparatus and the terminal apparatus will be described. A protocol used between the base station apparatus and the terminal apparatus may be used in communication performed between the relay terminal apparatus and the base station apparatus on the Uu interface and communication performed between the remote terminal apparatus and the base station apparatus via the relay terminal apparatus. Note that, in communication performed between the remote terminal apparatus and the base station apparatus via the relay terminal apparatus, some protocols may not be associated between the remote terminal apparatus and the base station apparatus.

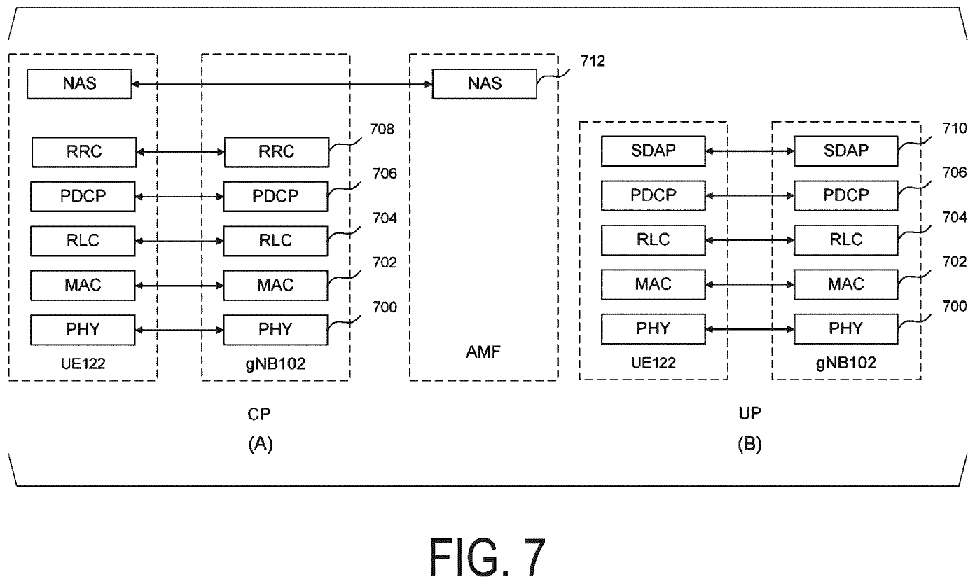

FIG. 7 is a diagram of an example of an NR protocol configuration according to the present embodiment. Functions of each protocol to be described with reference to FIG. 7 are a part of functions closely related to the present embodiment, and other functions may be provided. Note that, in the present embodiment, an uplink (UL) may be a link from the terminal apparatus to the base station apparatus. In the present embodiment, a downlink (DL) may be a link from the base station apparatus to the terminal apparatus.

FIG. 7(A) is a diagram of an NR control plane (CP) protocol stack. As illustrated in FIG. 7(A), the NR CP protocol may be a protocol between the UE 122 and the gNB 102. In other words, the NR CP protocol may be a protocol terminated at the gNB 102 on the network side. As illustrated in FIG. 7(A), the NR control plane protocol stack may include a Physical layer (PHY) 700 that is a radio physical layer, a Medium Access Control (MAC) 702 that is a medium access control layer, a Radio Link Control (RLC) 704 that is a radio link control layer, a Packet Data Convergence Protocol (PDCP) 706 that is a packet data convergence protocol layer, and a Radio Resource Control (RRC) 708 that is a radio resource control layer. In addition, FIG. 7(B) is a diagram of an NR user plane (UP) protocol stack. As illustrated in FIG. 7(B), the NR UP protocol may be a protocol between the UE 122 and the gNB 102. In other words, the NR UP protocol may be a protocol terminated at the gNB 102 on the network side. As illustrated in FIG. 7(B), the NR user plane protocol stack may include a PHY 700 that is a radio physical layer, a MAC 702 that is a medium access control layer, an RLC 704 that is a radio link control layer, a PDCP 706 that is a packet data convergence protocol layer, and a Service Data Adaptation Protocol (SDAP) 710 that is a service data adaptation protocol layer.

Note that the Access Stratum (AS) layer may be a layer terminated between the UE 122 and the gNB 102. That is, the AS layer may be a layer including some or all of the PHY 700, the MAC 702, the RLC 704, the PDCP 706, and the RRC 708. In addition, the gNB 102 may also be ng-eNB 100. In addition, although only the NR protocol is illustrated, the E-UTRA protocol may be used. In the E-UTRA protocol, there may be no SDAP 710, and the E-UTRA protocol may have a function that is partially different from that of the NR protocol.

An example of the functions of the PHY will be described. The PHY of the terminal apparatus may have a function of receiving data transmitted from the PHY of the base station apparatus via a Downlink (DL) Physical Channel. The PHY of the terminal apparatus may have a function of transmitting data to the PHY of the base station apparatus via an Uplink (UL) physical channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Now, the physical channels will be described. The physical channels used for radio communication between the terminal apparatus and the base station apparatus may include the following physical channels.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH may be used to broadcast system information required by the terminal apparatus.

The PBCH may be used to broadcast time indexes (SSB-Indexes) within the periodicity of Synchronization Signal Blocks (SSBs) in NR.

The PDCCH may be used to transmit (or carry) Downlink Control Information (DCI) in downlink radio communication (radio communication from the base station apparatus to the terminal apparatus). Here, one or multiple pieces of DCI (which may be referred to as DCI formats) may be defined for transmission of the downlink control information. In other words, a field for the downlink control information may be defined as DCI and may be mapped to information bits. The PDCCH may be transmitted in PDCCH candidates. The terminal apparatus may monitor a set of PDCCH candidates in a serving cell. To monitor a set of PDCCH candidates may mean an attempt to decode the PDCCH in accordance with a certain DCI format. In addition, the terminal apparatus may monitor the PDCCH candidates in monitoring occasions configured in one or multiple configured control resource sets (CORESETs) configured by a search space configuration. The DCI format may be used for scheduling of the PUSCH in the serving cell. The PUSCH may be used for transmission of user data, transmission of RRC messages to be described below, and the like.

PDCCH repetition may be operated by using two search space sets explicitly linked by a configuration provided by a higher layer (RRC layer). In addition, the two linked search space sets may be associated with a corresponding CORESET. For PDCCH repetition, two linked search space sets may be configured for the terminal apparatus together with the same number of PDCCH candidates. Two PDCCH candidates present in the two linked search space sets may be linked by the same candidate index. When PDCCH repetition is scheduled for the terminal apparatus, inter-slot repetition may be allowed, and each repetition operation may have the same number of Control Channel Elements (CCEs), coded bits, and the same DCI payload.

The PUCCH is used to transmit Uplink Control Information (UCI) in a case of uplink radio communication (radio communication from the terminal apparatus to the base station apparatus). Here, the uplink control information may include Channel State Information (CSI) used to indicate a state of a downlink channel. The uplink control information may include a Scheduling Request (SR) used for requesting Uplink Shared CHannel (UL-SCH) resources. The uplink control information may include a Hybrid Automatic Repeat reQuest ACKnowledgement (HARQ-ACK).

The PDSCH may be used to transmit downlink data (Downlink Shared CHannel (DL-SCH) from the MAC layer. In a case of the downlink, the PDSCH may be used to transmit System Information (SI), a Random Access Response (RAR), and the like.

The PUSCH may be used to transmit uplink data (Uplink-Shared CHannel (UL-SCH)) from the MAC layer or to transmit the HARQ-ACK and/or CSI along with the uplink data. The PUSCH may be used to transmit CSI only or a HARQ-ACK and CSI only. In other words, the PUSCH may be used to transmit the UCI only. In addition, the PDSCH or the PUSCH may be used to transmit an RRC message and a MAC CE. Here, in the PDSCH, the RRC message transmitted from the base station apparatus may be signalling common to multiple terminal apparatuses within a cell. In addition, the RRC message transmitted from the base station apparatus may be dedicated signaling for a certain terminal apparatus. In other words, terminal apparatus-specific (UE-specific) information may be transmitted using dedicated signaling to the certain terminal apparatus. Additionally, the PUSCH may be used to transmit UE capabilities in the uplink.

The PRACH may be used for transmitting a random access preamble. The PRACH may be used to indicate an initial connection establishment procedure, a handover procedure, a connection re-establishment procedure, synchronization (timing adjustment) for uplink transmission, and a request for a UL-SCH resource.

Uplink (UL) and/or Downlink (DL) logical channels used in E-UTRA and/or NR will be described.

A Broadcast Control Channel (BCCH) may be a downlink logical channel for broadcasting control information, such as System Information (SI).

A Paging Control Channel (PCCH) may be a downlink logical channel for carrying a Paging message.

A Common Control Channel (CCCH) may be a logical channel for transmitting control information between the terminal apparatus and the base station apparatus. The CCCH may be used in a case that the terminal apparatus does not have RRC connection. The CCCH may be used between the base station apparatus and multiple terminal apparatuses.

A Dedicated Control Channel (DCCH) may be a logical channel for transmitting dedicated control information in a point-to-point bi-directional manner between the terminal apparatus and the base station apparatus. The dedicated control information may be control information dedicated to each terminal apparatus. The DCCH may be used in a case that the terminal apparatus has RRC connection.

A Dedicated Traffic Channel (DTCH) may be a logical channel for transmitting user data in a point-to-point manner between the terminal apparatus and the base station apparatus. The DTCH may be a logical channel for transmitting dedicated user data. The dedicated user data may be user data dedicated to each terminal apparatus. The DTCH may be present in both of the uplink and the downlink.

Mapping between the logical channels and the transport channels in uplink, in E-UTRA and/or NR will be described.

The CCCH may be mapped to an Uplink Shared Channel (UL-SCH) being an uplink transport channel.

The DCCH may be mapped to an Uplink Shared Channel (UL-SCH) being an uplink transport channel.

The DTCH may be mapped to an Uplink Shared Channel (UL-SCH) being an uplink transport channel.

Mapping between the logical channels and the transport channels in downlink, in E-UTRA and/or NR will be described.

The BCCH may be mapped to a Broadcast Channel (BCH) and/or a Downlink Shared Channel (DL-SCH) being a downlink transport channel.

The PCCH may be mapped to a Paging Channel (PCH) being a downlink transport channel.

The CCCH may be mapped to a Downlink Shared Channel (DL-SCH) being a downlink transport channel.

The DCCH may be mapped to a Downlink Shared Channel (DL-SCH) being a downlink transport channel.

The DTCH may be mapped to a Downlink Shared Channel (DL-SCH) being a downlink transport channel.

An example of the functions of the SDAP will be described. The SDAP is a service data adaptation protocol layer. The SDAP may have a function of performing association (mapping) between a downlink QoS flow transmitted from the 5GC to the terminal apparatus via the base station apparatus and a data radio bearer (DRB) and/or mapping between an uplink QoS flow transmitted from the terminal apparatus to the 5GC via the base station apparatus and a DRB. The SDAP may have a function of storing mapping rule information. The SDAP may have a function of performing marking of a QoS flow identifier (QoS Flow ID (QFI). Note that the SDAP PDU may include an SDAP PDU for data and an SDAP PDU for control. The SDAP PDU for data may be referred to as an SDAP DATA PDU (SDAP Data PDU, SDAP data PDU). The SDAP PDU for control may be referred to as an SDAP CONTROL PDU (SDAP Control PDU, SDAP control PDU). Note that, in the terminal apparatus, one SDAP entity may be present for one PDU session.

An example of the functions of the RRC will be described. The RRC may have a broadcast function. The RRC may have a function of paging from the 5GC. The RRC may have a function of paging from the gNB 102 or the ng-eNB 100. The RRC may have an RRC connection management function. The RRC may have a radio bearer control function. The RRC may have a cell group control function. The RRC may have a mobility control function. The RRC may have terminal apparatus measurement reporting and terminal apparatus measurement reporting control functions. The RRC may have a QoS management function, The RRC may have radio link failure detection and recovery functions. The RRC may perform broadcasting, paging, RRC connection management, radio bearer control, cell group control, mobility control, terminal apparatus measurement reporting and terminal apparatus measurement reporting control, QoS management, detection and recovery of radio link failure, and the like by using RRC messages. Note that RRC messages and parameters used in the E-UTRA RRC may be different from RRC messages and parameters used in the NR RRC.

The RRC message may be transmitted using the BCCH of the logical channel, may be transmitted using the PCCH of the logical channel, may be transmitted using the CCCH of the logical channel, or may be transmitted using the DCCH of the logical channel. The RRC message transmitted using the DCCH may be called dedicated RRC signalling or RRC signalling.

In the RRC message transmitted using the BCCH, for example, a Master Information Block (MIB) may be included, a System Information Block (SIB) of each type may be included, or another RRC message may be included. In the RRC message transmitted using the PCCH, for example, a paging message may be included, or another RRC message may be included.

In the RRC message transmitted in the uplink (UL) direction using the CCCH, for example, an RRC setup request message (RRC Setup Request), an RRC resume request message (RRC Resume Request), an RRC reestablishment request message (RRC Reestablishment Request), an RRC system information request message (RRC System Info Request), and the like may be included. For example, an RRC connection request message (RRC Connection Request), an RRC connection resume request message (RRC Connection Resume Request), an RRC connection reestablishment request message (RRC Connection Reestablishment Request), and the like may be included. Another RRC message may be included.

In the RRC message transmitted in the downlink (DL) direction using the CCCH, for example, an RRC connection reject message (RRC Connection Reject), an RRC connection setup message (RRC Connection Setup), an RRC connection reestablishment message (RRC Connection Reestablishment), an RRC connection reestablishment reject message (RRC Connection Reestablishment Reject), and the like may be included. For example, an RRC reject message (RRC Reject), an RRC setup message (RRC Setup), and the like may be included. Another RRC message may be included.

In the RRC signalling transmitted in the uplink (UL) direction using the DCCH, for example, a measurement report message (Measurement Report), an RRC connection reconfiguration complete message (RRC Connection Reconfiguration Complete), an RRC connection setup complete message (RRC Connection Setup Complete), an RRC connection reestablishment complete message (RRC Connection Reestablishment Complete), a security mode complete message (Security Mode Complete), a UE capability information message (UE Capability Information), and the like may be included. For example, a measurement report message (Measurement Report), an RRC reconfiguration complete message (RRC Reconfiguration Complete), an RRC setup complete message (RRC Setup Complete), an RRC reestablishment complete message (RRC Reestablishment Complete), an RRC resume complete message (RRC Resume Complete), a security mode complete message (Security Mode Complete), a UE capability information message (UE Capability Information), and the like may be included. Another RRC signalling may be included.

In the RRC signalling transmitted in the downlink (DL) direction using the DCCH, for example, an RRC connection reconfiguration message (RRC Connection Reconfiguration), an RRC connection release message (RRC Connection Release), a security mode command message (Security Mode Command), a UE capability enquiry message (UE Capability Enquiry), and the like may be included. For example, an RRC reconfiguration message (RRC Reconfiguration), an RRC resume message (RRC Resume), an RRC release message (RRC Release), an RRC reestablishment message (RRC Reestablishment), a security mode command message (Security Mode Command), a UE capability enquiry message (UE Capability Enquiry), and the like may be included. Another RRC signalling may be included.

The functions of the PHY, the MAC, the RLC, the PDCP, the SDAP, and the RRC described above are merely an example, and some or all of the functions may not be implemented. Some or all of the functions of each layer may be included in another layer.

The radio bearers will be described. In a case that the terminal apparatus communicates with the base station apparatus, radio connection may be performed by establishing a Radio Bearer (RB) between the terminal apparatus and the base station apparatus. The radio bearer used for the CP may be referred to as a Signaling Radio Bearer (SRB). The radio bearer used for the UP may be referred to as a Data Radio Bearer (DRB). Each radio bearer may be assigned a radio bearer identity (Identity (ID)). The radio bearer identity for the SRB may be referred to as an SRB identity (SRB Identity or SRB ID). The radio bearer identity for the DRB may be referred to as a DRB identity (DRB Identity or DRB ID). For the SRBs of E-UTRA, SRB0 to SRB2 may be defined, or SRBs other than these may be defined. For the SRBs of NR, SRB0 to SRB3 may be defined, or SRBs other than these may be defined. SRB0 may be an SRB for an RRC message transmitted and/or received using the CCCH of the logical channel. SRB1 may be an SRB for RRC signalling, and for NAS signalling before establishment of SRB2. The RRC signalling transmitted and/or received using SRB1 may include a piggybacked NAS signalling. For all of RRC signalling and NAS signalling transmitted and/or received using SRB1, the DCCH of the logical channel may be used. SRB2 may be an SRB for NAS signalling, and for RRC signalling including logged measurement information. For all of RRC signalling and NAS signalling transmitted and/or received using SRB2, the DCCH of the logical channel may be used. SRB2 may have a lower priority than SRB1. SRB3 may be an SRB for transmitting and/or receiving specific RRC signalling in a case that EN-DC, NGEN-DC, NR-DC, or the like is configured for the terminal apparatus. For all of RRC signalling and NAS signalling transmitted and/or received using SRB3, the DCCH of the logical channel may be used. Other SRBs may also be provided for other applications. The DRB may be a radio bearer for user data. For RRC signalling transmitted and/or received using the DRB, the DTCH of the logical channel may be used.

The radio bearers in the terminal apparatus will be described. The radio bearers include an RLC bearer. The RLC bearer may include one or two RLC entities and a logical channel. The RLC entities in a case that the RLC bearer includes two RLC entities may be the transmitting RLC entity and the receiving RLC entity in the TM RLC entity and/or the uni-directional UM mode RLC entity. SRB0 may include one RLC bearer. The RLC bearer of SRB0 may include the RLC entity of TM, and a logical channel. SRB0 may be constantly established in the terminal apparatus in all of the states (an RRC idle state, an RRC connected state, an RRC inactive state, etc.). In a case that the terminal apparatus transitions from the RRC idle state to the RRC connected state, one SRB1 may be established and/or configured for the terminal apparatus, using RRC signalling received from the base station apparatus. SRB1 may include one PDCP entity, and one or multiple RLC bearers. The RLC bearer of SRB1 may include the RLC entity of AM, and a logical channel. One SRB2 may be established and/or configured for the terminal apparatus, using RRC signalling that the terminal apparatus in the RRC connected state with activated AS security receives from the base station apparatus. SRB2 may include one PDCP entity, and one or multiple RLC bearers. The RLC bearer of SRB2 may include the RLC entity of AM, and a logical channel. Note that the PDCP of SRB1 and SRB2 on the base station apparatus side may be deployed in the master node. In a case that a secondary node in EN-DC, NGEN-DC, or NR-DC is added or in a case that the secondary node is changed, one SRB3 may be established and/or configured for the terminal apparatus, using RRC signalling that the terminal apparatus in the RRC connected state with activated AS security receives from the base station apparatus. SRB3 may be a direct SRB between the terminal apparatus and the secondary node. SRB3 may include one PDCP entity, and one or multiple RLC bearers. The RLC bearer of SRB3 may include the RLC entity of AM, and a logical channel. The PDCP of the SRB3 on the base station apparatus side may be deployed in the secondary node. One DRB may be established and/or configured for the terminal apparatus, using RRC signalling that the terminal apparatus in the RRC connected state with activated AS security receives from the base station apparatus. The DRB may include one PDCP entity, and one or multiple RLC bearers. The RLC bearer of the DRB may include the RLC entity of AM or UM, and a logical channel.

The RLC entity established and/or configured for the RLC bearer established and/or configured for the cell group configured in E-UTRA may be the E-UTRA RLC. The RLC entity established and/or configured for the RLC bearer established and/or configured for the cell group configured in NR may be the NR RLC. In a case that EN-DC is configured for the terminal apparatus, the PDCP entity established and/or configured for the Master Node terminated MCG bearer may be either the E-UTRA PDCP or the NR PDCP. In addition, in a case that EN-DC is configured for the terminal apparatus, the PDCP established and/or configured for the radio bearers of other bearer types, i.e., a Master Node terminated split bearer, a Master Node terminated SCG bearer, a Secondary Node terminated MCG bearer, a Secondary Node terminated split bearer, and a Secondary Node terminated SCG bearer, may be the NR PDCP. In addition, in a case that NGEN-DC, NE-DC, or NR-DC is configured for the terminal apparatus, the PDCP entity established and/or configured for the radio bearers of all of the bearer types may be the NR PDCP.

Note that, in NR, the DRB established and/or configured for the terminal apparatus may be linked to one PDU session. One SDAP entity may be established and/or configured for one PDU session in the terminal apparatus. The SDAP entity, the PDCP entity, the RLC entity, and the logical channel established and/or configured for the terminal apparatus may be established and/or configured using RRC signalling that the terminal apparatus receives from the base station apparatus.

The operations of the RRC, the PDCP, and the RLC closely related to the present embodiment will be described. First, PDCP data recovery and PDCP re-establishment will be described. The RRC signalling transmitted from the base station apparatus to the terminal apparatus may include information elements related to the configuration of the radio bearers (RadioBearerConfig), the information elements related to the configuration of the radio bearers may include a list (DRB-ToAddModList) of configurations (DRB-ToAddMod) related to the addition and/or modification of the DRBs, and the configurations related to the addition and/or modification of the DRBs may include a DRB identity (drb-Identity), information indicating that the PDCP is re-established (reestablishPDCP), and information indicating that the PDCP performs data recovery (recoverPDCP). The RRC of the terminal apparatus may re-establish the PDCP entity of the DRB identified by the DRB identity based on the information indicating that the PDCP is re-established being set in the RRC signalling, and the RRC of the terminal apparatus may trigger data recovery of the PDCP entity configured for the DRB identified by the DRB identity based on the information indicating that the PDCP performs data recovery being set in the RRC signalling. In a case that the information indicating that the PDCP is re-established and the information indicating that the PDCP performs data recovery are included in the configuration related to the addition and/or modification of the DRB identified by one DRB identity, the RRC of the terminal apparatus may re-establish the PDCP entity of the DRB identified by the DRB identity, and may not trigger data recovery of the PDCP entity of the DRB identified by the DRB identity.

The PDCP entity having received a request for data recovery from the higher layer (RRC layer) may re-transmit all PDCP data PDUs that have been previously submitted to the re-established or released AM RLC entity in ascending order of the COUNT values associated with the PDUs without being confirmed by the lower layer for successful delivery.

The PDCP entity requested by the higher layer (RRC layer) to re-establish the PDCP entity may re-transmit or transmit all PDCP SDUs already associated with PDCP sequence numbers (SN(s)) in ascending order of COUNT values associated with the PDCP SDUs before the PDCP re-establishment, starting from the first PDCP SDU for which successful delivery of the PDCP data PDU corresponding to the PDCP SDU has not been confirmed by the lower layer. Note that, in a case that the DRB including the PDCP entity requested to be re-established is suspended, the PDCP SDU may be considered to be received from the higher layer, and the PDCP SDU may be re-transmitted without re-starting a discard timer (discardTimer).

One PDCP entity may include a transmitting PDCP entity and a receiving PDCP entity. The transmitting PDCP entity receiving the PDCP SDU from the higher layer may start a discard timer associated with the PDCP SDU. In a case that a discard timer for the PDCP SDU expires or that successful delivery of the PDCP SDU is confirmed by a PDCP status report, the transmitting PDCP entity may discard the PDCP SDU with the corresponding PDCP data PDU. If the PDCP data PDU has already been submitted to the lower layer, the lower layer may be indicated to discard the PDCP data PDU.

For an AM DRB configured to send a PDCP status report in uplink to the higher layer (RRC), the receiving PDCP entity may trigger the PDCP status report in a case that the higher layer (RRC) requests re-establishment of the PDCP entity, in a case that the higher layer (RRC) requests PDCP data recovery, in a case that the higher layer (RRC) requests switching of uplink data, or the like. The RRC of the terminal apparatus may configure the DRB identified by the DRB identity to send the PDCP status report in uplink, based on the fact that the information (statusReportRequired) indicating sending the PDCP status report in uplink is included in the configuration of the PDCP entity (pdcp-Config) included in the configuration related to addition and/or modification of the DRB. In a case that the PDCP status report is triggered, the receiving PDCP entity may submit the PDCP status report to a lower layer as a first PDCP PDU for transmission via the transmitting PDCP entity.

A control PDCP PDU may be used to convey a PDCP status report to the peer PDCP. Note that the control PDCP PDU may also be used to transmit control information other than the PDCP status report. The PDCP status report may include information indicating whether the PDCP PDU is for control or for data, information indicating which control information is included among the control information included in the control PDCP PDU, a reserved bit, information indicating the first PDCP PDU missing within a reordering window (First Missing COUNT: FMC), and bitmap information indicating the missing PDCP SDU and the successfully received PDCP SDU.

In a case that the PDCP status report is received in downlink, the transmission PDCP entity may consider the COUNT value corresponding to the bit indicated by 1 in the bitmap information included in the PDCP status report and/or the PDCP SDU corresponding to the COUNT value smaller than the value indicated by the FMC as successful delivery, and discard the PDCP SDU considered as successful delivery.

The AM RLC entity on the transmitting side can receive a positive ACKnowledgment (ACK) for a certain RLC SDU according to a status PDU from a peer AM RLC entity. When receiving an ACK for a certain RLC SDU associated with a certain RLC sequence number, the AM RLC entity on the transmitting side may signal the successful delivery of the RLC SDU to the higher layer. In addition, in a case that discarding of a specific RLC SDU is indicated from the higher layer (PDCP), if the indicated RLC SDU or a segment thereof is not submitted to the lower layer, the transmitting side of the AM RLC entity may discard the indicated RLC SDU.

The Reference Signal Received Power (RSRP) measured in the sidelink may be, for example, the following RSRP. The following RSRP may be referred to as SL-RSRP.
(a) PSBCH RSRP
(b) PSSCH RSRP
(c) PSCCH RSRP

The PSBCH-RSRP (PSBCH RSRP) may be defined as a linear average of power contributions of resource elements carrying multiple Demodulation Reference Signals (DMRSs) associated with the PSBCH. The PSSCH-RSRP (PSSCH RSRP) may be defined as a linear average of power contributions of resource elements of antenna ports transmitting multiple DMRSs associated with the PSSCH, and in a case that there are multiple antenna ports, values of RSRP for each antenna port may be summed. The PSCCH-RSRP (PSCCH RSRP) may be defined as a linear average of power contributions of resource elements carrying multiple DMRS associated with the PSCCH. Note that the DMRS may be used to demodulate, for example, signals of the PSBCH, the PSSCH, and the PSCCH. Furthermore, the terminal apparatus that performs sidelink communication with another terminal apparatus may measure the RSRP (SL-RSRP) of the sidelink communication by using the PSSCH or the PSCCH that is transmitted from the other terminal apparatus. The terminal, the terminal apparatus may measure the RSRP (SD-RSRP) of the discovery message using the power contribution of a resource element that transmits the DMRS associated with the discovery message.

In the measurement in the sidelink, the UE 122 may measure the following quantities in addition to the SL-RSRP.
(a) Sidelink received signal strength indicator (SL RSSI)
(b) Sidelink channel Occupancy ratio (SL CR)
(c) Sidelink channel busy ratio (SL CBR)

The SL RSSI may be defined as a linear average of power ([W]) observed in a configured subchannel within an OFDM symbol of a slot configured for the PSCCH and the PSSCH, starting from a second OFDM symbol. In addition, the SL CR in a slot n may be defined as the value obtained by dividing the sum of the number of subchannels used for sidelink transmission between a slot [n−a] and slot [n−1] and the number of subchannels allocated between a slot [n] and a slot [n+b] by the sum of the number of subchannels configured between a slot [n−a] and a slot [n+b]. In addition, the SL CBR in the slot n may be defined as a ratio of subchannels whose SLRSSI exceeds a threshold value in a resource pool during a period configured as a CBR measuring window (from the slot [n−a] to the slot [n−1]).

After the L2 U2N Remote UE discovers a candidate L2 U2N Relay UE and measures the RSRP of the candidate L2 U2N Relay UE, the L2 U2N Remote UE may report one or more candidate L2 U2N Relay UEs to the base station apparatus. Note that, before reporting one or more candidate L2 U2N Relay UEs to the base station apparatus, the L2 U2N Remote UE may determine whether the measured RSRP of the candidate L2 U2N Relay UE satisfies the selection criterion of L2 U2N relay. The L2 U2N Remote UE may report only the candidate L2 U2N Relay UE satisfying the selection criterion and matching a criterion of a higher layer to the base station apparatus. In addition, when reporting one or more candidate L2 U2N Relay UEs to the base station apparatus, the L2 U2N Remote UE may include identification information of the candidate L2 U2N Relay UEs, identification information of serving cells of the candidate L2 U2N Relay UEs, and measurement results in the report to the base station apparatus. Note that the RSRP (SD-RSRP) of the discovery messages transmitted by the candidate L2 U2N Relay UEs may be used as the measurement results. Note that the identification information may be an identifier (ID).

In addition, the L2 U2N Remote UE having the serving L2 U2N Relay UE may use the RSRP (SL-RSRP) measured in the sidelink communication with the serving L2 U2N Relay UE for the measurement results. Note that, in a case that the SL-RSRP cannot be used for the measurement results, SDRSRP may be used. Note that the serving L2 U2N Relay UE may be an L2 U2N Relay UE providing the L2 U2N Remote UE with connectivity to the base station apparatus.

Next, the serving cell will be described. In the terminal apparatus in the RRC connected state in which carrier aggregation (CA) and/or multi-connectivity (MC) are not configured, the serving cell may include one primary cell (PCell). In addition, the terminal apparatus in the RRC connected state in which CA and/or MC are configured, multiple serving cells may mean a set of cell(s) including one or more special cells (SpCells) and one or more all secondary cells (SCells). The SpCell may support PUCCH transmission and contention-based Random Access (CBRA). The PCell may be a cell used for an RRC connection establishment procedure in a case that the terminal apparatus in the RRC idle state transitions to the RRC connected state. The PCell may be a cell used for an RRC connection re-establishment procedure in which the terminal apparatus performs re-establishment of RRC connection. The PCell may be a cell used for a random access procedure in a case of a handover. The PSCell may be a cell used for the random access procedure in a case of addition of a secondary node for MC. The PCell and the PSCell may be SpCells. The SpCell may be a cell used for purposes other than the purposes described above.

Based on the above description, various examples of the present embodiment will be described. Note that the processing described above may be applied to processing not described in the following.

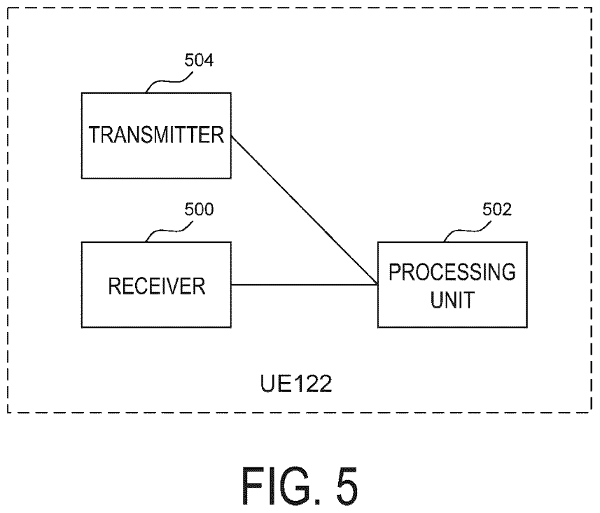

FIG. 5 is a block diagram illustrating a configuration of the terminal apparatus (UE 122) according to the present embodiment. Note that FIG. 5 illustrates only the main components closely related to the present embodiment in order to avoid complexity of description.

The UE 122 illustrated in FIG. 5 includes a receiver 500 that receives control information (SCI, MAC control elements, RRC signalling, and the like), information including the discovery message and user data, and the like from another terminal apparatus, a processing unit 502 that performs processing in accordance with parameters included in the received control information and the like, and a transmitter 504 that transmits control information (SCI, MAC control elements, RRC signalling, and the like), information including the discovery message and user data, and the like to another terminal apparatus. In addition, the receiver 500 may receive control information (MAC control elements, RRC signalling, etc.), user-data-containing information, and the like from the base station apparatus (gNB 102). In addition, the transmitter 504 may transmit control information (MAC control elements, RRC signalling, etc.), user-data-containing information, and the like to the base station apparatus (gNB 102). The processing unit 502 may include a part or all of functions of various layers (for example, the physical layer, the MAC layer, the RLC layer, the PDCP layer, the SDAP layer, the RRC layer, the PC5-S layer, the Discovery layer, and an application layer). That is, the processing unit 502 may include a part or all of a physical layer processing unit (PHY processing unit), a MAC layer processing unit (MAC processing unit), an RLC layer processing unit (RLC processing unit), a PDCP layer processing unit (PDCP processing unit), an SDAP processing unit, an RRC layer processing unit (RRC processing unit), a PC5-S layer processing unit (PC5-S processing unit), a Discovery layer processing unit (Discovery processing unit), and an application layer processing unit.

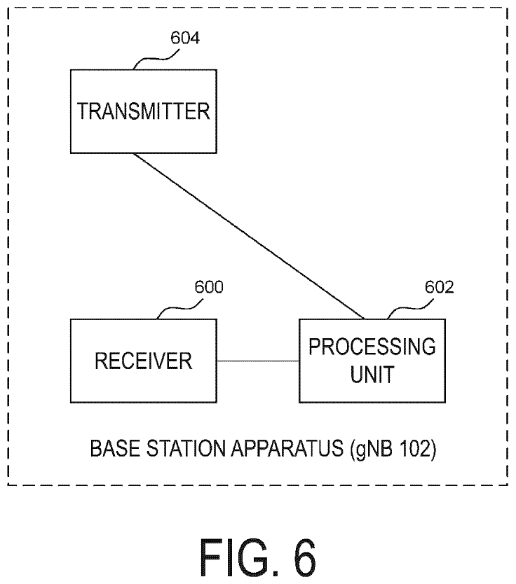

FIG. 6 is a block diagram illustrating a configuration of the base station apparatus (gNB 102) according to the present embodiment. Note that FIG. 6 illustrates only the main components closely related to the present embodiment in order to avoid complexity of description.

The base station apparatus illustrated in FIG. 6 includes a transmitter 604 that transmits control information (DCI, MAC CE, RRC signalling, etc.) to the UE 122, a processing unit 602 that creates control information (DCI, MAC CE, RRC signalling, etc.) and transmits the control information to the UE 122 to thereby cause the processing unit 502 of the UE 122 to perform processing, and a receiver 600 that receives the control information (UCI, MAC CE, RRC signalling, etc.) from the UE 122. In addition, the processing unit 602 may include some or all of functions of various layers (for example, the physical layer, the MAC layer, the RLC layer, the SRAP layer, the PDCP layer, the SDAP layer, the RRC layer, and the NAS layer). In other words, the processing unit 602 may include some or all of a physical layer processing unit, a MAC layer processing unit, an RLC layer processing unit, an SRAP layer processing unit, a PDCP layer processing unit, an SDAP processing unit, an RRC layer processing unit, and a NAS layer processing unit.

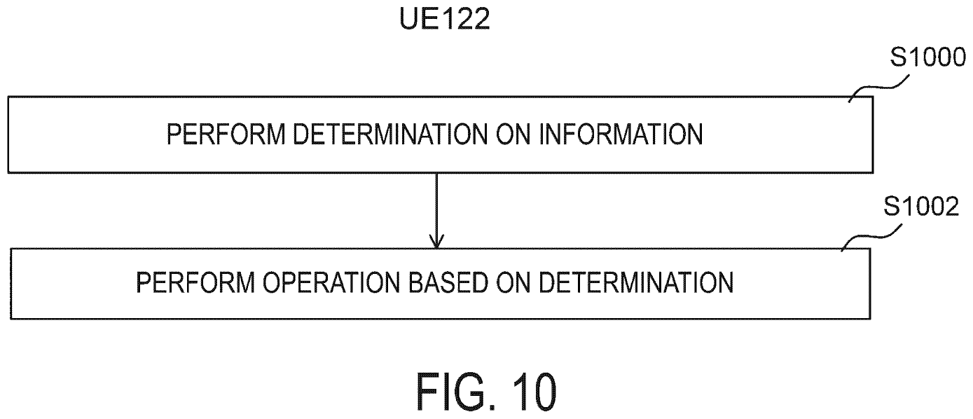

An example of an embodiment of the present invention will be described with reference to FIG. 10.

The UE 122 communicating with the base station apparatus performs determination on the information (step S1000) and performs an operation based on the determination (step S1002).

The RRC layer of the UE having received first RRC signalling and second RRC signalling from the base station apparatus may give an indication to the lower layer (PDCP layer) based on the first RRC signalling and the second RRC signalling. The information in step S1000 may be, for example, the indication. The PDCP layer having received the information from the higher layer (RRC layer) may determine, for example, whether the first information is included in the information in step S1000. The PDCP layer in the UE 122 may perform a first operation, for example, in step S1002 in a case that it is determined that the first information is included in the information, and may perform a second operation, for example, in step S1002 in a case that it is determined that the first information is not included in the information, and may perform a second operation. The first information may be information indicating that the terminal apparatus is a remote terminal apparatus, or may be information indicating that the first operation is to be performed. In addition, the first RRC signalling may be an RRC message including a configuration for a remote terminal apparatus, or may be an RRC message including information indicating that the first operation is to be performed. The second RRC signalling may be an RRC message including information indicating that PDCP data recovery is to be performed, or may be an RRC message including information indicating that PDCP re-establishment is to be performed.

The RRC layer in the UE 122 may determine whether to perform a first configuration based on the first RRC signalling. For example, the first configuration may be performed based on the fact that a configuration for the remote terminal apparatus is included in the first RRC signalling, or the first configuration may not be performed based on the fact that the configuration for the remote terminal apparatus is not included in the first RRC signalling. For example, the first configuration may be performed based on the fact that the first RRC signalling includes information indicating that the first operation is to be performed, or for example, the first configuration may not be performed based on the fact that the first RRC signalling does not include the information indicating that the first operation is to be performed. In addition, the RRC layer of the UE 122 may determine whether to provide the first information to a lower layer based on whether the first configuration has been performed. For example, the RRC layer in the UE 122 may determine to provide the first information to the lower layer based on the fact that the first configuration has been performed, or may determine not to provide the first information to the lower layer based on the fact that the first configuration has not been performed. Note that the first RRC signalling and the second RRC signalling may be one RRC signalling. For example, the RRC signalling may be RRC signalling including information indicating that the first operation is to be performed and information indicating that the PDCP data recovery is to be performed, may be RRC signalling including information indicating that, for example, the first operation is to be performed and information indicating that PDCP re-establishment is to be performed, or may be another combination.

In addition, the RRC layer in the UE 122 may determine the information based on the second RRC signalling. In a case that the second signalling includes information indicating that PDCP data recovery is to be performed, it may be determined to indicate the lower layer to perform PDCP data recovery, or in a case that the second signalling includes information indicating that PDCP re-establishment is to be performed, it may be determined to indicate the lower layer to perform PDCP re-establishment. Note that giving an indication to the lower layer may be rephrased as providing information to the lower layer.

In a case that the information includes information giving an indication to perform PDCP data recovery, the first operation may be performing re-transmission of all PDCP data PDUs previously submitted to the re-established or released AM RLC entity. All the PDCP data PDUs may be rephrased as all the PDCP data PDUs that have not been discarded. In addition, the first operation may be performing re-transmission or transmission of all PDCP SDUs already associated with PDCP SNs in ascending order of COUNT values associated with the PDCP SDUs before re-establishment of the PDCP entity, starting from the first PDCP SDU in a case that the information includes information indicating that PDCP re-establishment is to be performed. All the PDCP SDUs may be rephrased as all the PDCP SDUs that have not been discarded. The second operation may be performing re-transmission of all PDCP data PDUs that were previously submitted to the re-established or released AM RLC entity and are involved with successful transmission of corresponding PDCP data PDUs not confirmed by the lower layer in a case that the information includes information giving an indication to perform PDCP data recovery. In addition, the second operation may be performing re-transmission or transmission of all PDCP SDUs that have already been associated with PDCP SNs and are involved with successful transmission of corresponding PDCP data PDUs not confirmed by the lower layer in ascending order of COUNT values associated with the PDCP SDUs before re-establishment of the PDCP entity, starting from the first PDCP SDU in a case that the information includes information indicating that PDCP re-establishment is to be performed. Note that the term “successful transmission” may be rephrased as the term “successful delivery”.

Note that, the UE 122 may communicate with the base station apparatus via the relay terminal apparatus. In other words, the UE 122 may be a terminal apparatus that plays the role of a remote terminal apparatus. Note that, in a case that the first RRC signalling includes a configuration for the remote terminal apparatus, the second RRC signalling includes information indicating that PDCP data recovery is to be performed or information indicating that PDCP re-establishment is to be performed, the first RRC signalling and the second RRC signalling are single RRC signalling, and the terminal apparatus has not served as a remote terminal apparatus immediately before receiving the RRC signalling, the terminal apparatus may not perform the first operation. In other words, the terminal apparatus may not perform the first operation upon receiving the second RRC signalling including the information indicating that PDCP data recovery is to be performed or the information indicating that PDCP re-establishment is to be performed when the terminal apparatus is not playing the role of a remote terminal apparatus. Note that the configuration for the remote terminal apparatus may be, for example, a configuration related to U2N relay used by the remote terminal apparatus, which is included in an RRC message, and the configuration related to U2N relay used by the remote terminal apparatus may include a configuration of the SRAP layer used for the remote terminal apparatus.

In addition, an example of another embodiment of the present invention will be described with reference to FIG. 10.

The UE 122 that communicates with the base station apparatus and the relay terminal apparatus performs determination on the information (step S1000) and performs an operation based on the determination (step S1002).

In step S1000, for example, the determining may be that an RRC entity of the UE 122 receives first indication information from a higher layer, and determines whether the PC5 unicast link to which the UE 122 is connected is a target of the first indication information. Additionally or alternatively, the determination may be determining that the RRC connection re-establishment procedure is not being performed at the timing at which the first indication information is received.

Additionally or alternatively, the determining in step S1000 may be, for example, determining whether the first indication information is an indication to release a PC5 unicast link to a serving relay terminal apparatus. In this case, in step S1002, the operation may be releasing the PC5 unicast link and initiating the RRC re-establishment procedure based on the fact that the first indication information has been determined to be an indication to release the PC5 unicast link to the serving relay terminal apparatus, and releasing the PC5 unicast link and not initiating the RRC re-establishment procedure based on the fact that the first indication information has been determined to be an indication to release the PC5 unicast link to a terminal apparatus that is not the serving relay terminal apparatus.

Furthermore, in step S1002, the operations of releasing the PC5 unicast link and initiating the RRC connection re-establishment procedure may not necessarily be performed consecutively.

In addition, in FIG. 10, for example, the determination of the information in step S1000 may be determining whether some or all of the following conditions (a) to (c) are satisfied when the RRC entity of the UE 122 in the RRC connected state releases or has released the PC5 unicast link signaled from the higher layer.
(a) The RRC connection re-establishment procedure is not being performed.
(b) The released PC5 unicast link is a PC5 unicast link configured for communication with the serving relay terminal apparatus.
(c) Multi-path has not been configured (that is, not a multi-path remote terminal apparatus).

In step S1002, the RRC entity of the UE 122 may initiate the RRC connection re-establishment procedure based on the determination that some or all of the conditions (a) to (c) are satisfied. Additionally or alternatively, in step S1002, the RRC connection re-establishment procedure may not be initiated based on the determination that any of some or all of the conditions (a) to (c) is not satisfied.

In addition, the remote terminal apparatus, in step S1000 and/or step S1002 based on whether a multi-path is not configured, the remote terminal apparatus may perform different operations based on whether a multi-path is configured. For example, when the RRC entity of the UE 122 receives the first indication information from the higher layer, if it is determined that the UE 122 is a remote terminal apparatus for which a multi-path has been configured in step S1000, the RRC entity of the S1002 may not perform the initiation process of the RRC connection re-establishment procedure, and if it is determined that the UE 122 is a remote terminal apparatus for which a multi-path has not been configured, the RRC entity may perform the initiation process of the RRC connection re-establishment procedure. Note that the multi-path remote terminal apparatus may be a terminal apparatus for which a direct path and an indirect path are configured.

In each example, the remote terminal apparatus may be an L2 U2N Remote UE, and the relay terminal apparatus may be an L2 U2N relay UE. The remote terminal apparatus and the relay terminal apparatus may be referred to as names different from the names described in each example. Although the architecture of the U2N relay has been exemplified in the example of the present embodiment, the base station apparatus, the relay terminal apparatus, and the remote terminal apparatus may be replaced by other apparatuses.

In a case that the remote terminal apparatus that communicates with the base station apparatus via the relay terminal apparatus has a PC5 unicast link connection simultaneously with a terminal apparatus other than the relay terminal apparatus currently connected in a PC5 unicast link, when a path is switched to a cell as a handover destination, a relay terminal apparatus as a handover destination, or the like, an originally unnecessary RRC connection re-establishment procedure may be initiated upon reception of an indication to release the PC5 unicast link. According to the example of the present invention, the RRC connection re-establishment procedure is initiated only when an indication to release the PCS unicast link to the serving relay terminal apparatus is received from the higher layer, and the RRC connection re-establishment procedure is not performed when the RRC connection re-establishment procedure is not necessary, so efficient handover is possible.

In the example of each processing or the example of the flow of each processing in the above description, a part or all of the steps need not be performed. In the example of each processing or the example of the flow of each processing in the above description, the order of the steps may be different from each other. In the example of each processing or the example of the flow of each processing in the above description, a part or all of the processing in each step need not be performed. In the example of each processing or the example of the flow of each processing in the above description, the order of processing in each step may be different from each other. In the above description, “to perform B based on being A” may be rephrased as “to perform B”. In other words, “to perform B” may be performed independently of “being A”. In the above description, expressions such as “link”, “map”, and “associate” may be replaced with each other.

Note that in the above description, “A may be rephrased as B” may include the meaning that B is rephrased as A in addition to rephrasing of A as B. In a case that the above description contains “C may be D” and “C may be E”, this means inclusion of “D may be E”. In a case that the above description contains “F may be G” and “G may be H”, this may mean inclusion of “F may be H”.

In the above description, in a case that a condition “A” and a condition “B” are conflicting conditions, the condition “B” may be expressed as “other” condition of the condition “A”.

A program running on an apparatus according to the present embodiment may serve as a program that controls a Central Processing Unit (CPU) and the like to cause a computer to operate in such a manner as to realize the functions of the present embodiment. Programs or the information handled by the programs are temporarily loaded into a volatile memory such as a Random Access Memory (RAM) while being processed, or stored in a non-volatile memory such as a flash memory, or a Hard Disk Drive (HDD), and then read, modified, and written by the CPU, as necessary.

Note that the apparatuses in the above-described embodiment may be partially enabled by a computer. In this case, a program for implementing this control function may be implemented by recording the program in a computer-readable recording medium and causing a computer system to read and perform the program recorded in the recording medium. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically stores a program for a short period of time, such as a communication line in a case that the program is transmitted via a network such as the Internet or via a communication line such as a telephone line, and a medium that stores the program for a certain period of time, such as a volatile memory inside the computer system that is a server or a client in this case. Furthermore, the above-described program may be configured to realize some of the functions described above, and additionally may be configured to realize the functions described above, in combination with a program already recorded in the computer system.

Furthermore, each functional block or various characteristics of the apparatuses used in the above-described embodiments may be implemented or performed with an electric circuit, that is, typically an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or the processor may be a processor of known type, a controller, a micro-controller, or a state machine instead. The general-purpose processor or the above-mentioned circuits may include a digital circuit, or may include an analog circuit. Furthermore, in a case that with advances in semiconductor technology, a circuit integration technology appears that replaces the present integrated circuits, it is also possible to use an integrated circuit based on the technology.

Note that the present embodiment is not limited to the above-described embodiments. Although apparatuses have been described as an example in the embodiment, the present embodiment is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although the present embodiment has been described in detail above referring to the drawings, the specific configuration is not limited to the present embodiment and includes, for example, design changes within the scope that do not depart from the gist of the present embodiment. Furthermore, various modifications are possible within the scope of the present embodiment defined by claims, and embodiments that are made by suitably combining technical means disclosed according to the different embodiments are also included in the technical scope of the present embodiment. In addition, a configuration in which components, which are described in the embodiment described above, having similar effects are interchanged is also included in the present invention.

### Industrial Applicability

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

100 ng-eNB
102 gNB
110, 112, 114 Interface
122 UE
200, 700 PHY
202, 702 MAC
204, 704 RLC
206, 706 PDCP
208, 708 RRC
210 PC5-S
310, 710 SDAP
400 Discovery
500, 600 Receiver
502, 602 Processing unit
504, 604 Transmitter
712 NAS
800 SRAP

1. A terminal apparatus configured to communicate with a base station apparatus via a relay terminal apparatus, the terminal apparatus comprising:
an RRC entity,
wherein the RRC entity:
receives an indication to release a PC5 unicast link from a layer higher than an RRC layer; and
initiates a procedure of performing RRC connection re-establishment with respect to the base station apparatus, based on determining that the PC5 unicast link is a PC5 unicast link to the relay terminal apparatus.

2. A base station apparatus configured to communicate with a terminal apparatus via a relay terminal apparatus, the base station apparatus comprising:
an RRC entity,
wherein the RRC entity:
receives an indication to release a PC5 unicast link from a layer higher than an RRC layer; and
initiates a procedure of performing RRC connection re-establishment with respect to the terminal apparatus, based on determining that the PC5 unicast link is a PC5 unicast link to the relay terminal apparatus.

3. A method of a terminal apparatus configured to communicate with a base station apparatus via a relay terminal apparatus, the terminal apparatus comprising an RRC entity,
wherein the RRC entity:
receives an indication to release a PCS unicast link from a layer higher than an RRC layer; and
initiates a procedure of performing RRC connection re-establishment with respect to the base station apparatus, based on determining that the PC5 unicast link is a PC5 unicast link to the relay terminal apparatus.
